(19) United States
(12) Patent Application Publication
(10) Pub. No.: US 2025/0047647 A1
(43) Pub. Date: Feb. 6, 2025

(54) RELAY CONTROL DEVICE, RELAY CONTROL METHOD, AND COMPUTER-READABLE STORAGE MEDIUM

(71) Applicant: HONDA MOTOR CO.,LTD., Tokyo (JP)

(72) Inventors: Moriya HORIUCHI, Saitama (JP); Takahiro KUREHASHI, Saitama (JP); Yuta SAKAGAWA, Saitama (JP)

(21) Appl. No.: 18/738,050

(22) Filed: Jun. 9, 2024

(30) Foreign Application Priority Data
Jul. 31, 2023 (JP) 2023-124166

(51) Int. Cl. H04L 9/40

(52) U.S. Cl. CPC H04L 63/0421

(57) ABSTRACT

A relay control device includes: an information obtainment unit which obtains information obtained from a plurality of movable bodies; and a transmission control unit which performs control for transmitting information obtained from the plurality of movable bodies to a plurality of assistance devices, wherein the transmission control unit performs control for determining information to be transmitted with anonymization and information to be transmitted without anonymization among information obtained from a first movable body among the plurality of movable bodies for each destination assistance device and transmitting, with anonymization, information determined to be transmitted with anonymization and transmitting, without anonymizing, information determined not to be anonymized, to each of the plurality of assistance devices.

The contents of the following patent applications are incorporated herein by reference: NO. 2023-124166 filed in JP on Jul. 31, 2023.

### BACKGROUND

### 1. Technical Field

The present invention relates to a relay control device, a relay control method, and a computer-readable storage medium.

### 2. Related Art

In recent years, efforts have been intensified to provide access to a sustainable transportation system with consideration given to even vulnerable people among other traffic participants. To realize this, research and development has been focused on to further improve traffic safety and convenience through research and development regarding a preventive safety technique. Patent Document 1-3 describes a technique to process information to be transmitted from a vehicle.

### PRIOR ART DOCUMENT

### Patent Document

Patent Document 1: Japanese Patent Application Publication No. 2022-159038
Patent Document 2: Japanese Translation Publication of a PCT Route Patent Application No. 2022-507642
Patent Document 3: Japanese Patent Application Publication No. 2018-205830

### BRIEF DESCRIPTION OF THE DRAWINGS

FIG. 1 schematically shows a usage scene of an assistance system 10.

FIG. 2 shows a functional arrangement of a relay device 50.

FIG. 3 shows a data structure of configuration information for anonymizing the information to be transmitted to the relay device 50.

FIG. 4 shows an example of the information to be transmitted to an assistance device 60a.

FIG. 5 shows an example of the information to be transmitted to an assistance device 60b.

FIG. 6 shows an example of the execution sequence of the process by a capturing device 70, a user terminal 82, an in-vehicle processing device 40 included in a vehicle 20, a relay device 50 and an assistance device 60.

FIG. 7 shows an example of the flowchart related to an assistance control method performed by the assistance device 60.

FIG. 8 shows an example of a computer 2000.

### DESCRIPTION OF EXEMPLARY EMBODIMENTS

Hereinafter, embodiments of the present invention will be described. However, the following embodiments are not for limiting the invention according to the claims. In addition, not all of the combinations of features described in the embodiments are essential to the solution of the invention.

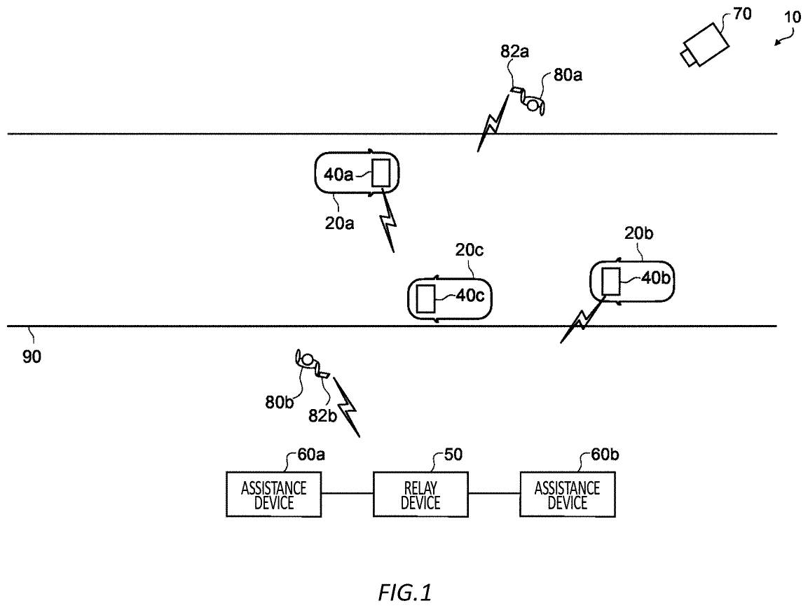

FIG. 1 schematically shows a usage scene of the assistance system 10. The assistance system 10 includes a vehicle 20a, a vehicle 20b, and a vehicle 20c, a user terminal 82a and a user terminal 82b, a relay device 50, an assistance device 60a, and an assistance device 60b, and a capturing device 70.

The vehicle 20a includes an in-vehicle processing device 40a, the vehicle 20b includes an in-vehicle processing device 40b, and the vehicle 20c includes an in-vehicle processing device 40c. The vehicle 20a and the vehicle 20b are vehicles in motion and the vehicle 20c is a vehicle at rest. The user terminal 82a is a terminal carried by the user 80a and the user terminal 82b is a terminal carried by the user 80b. In the present embodiment, the user 80a and the user 80b are pedestrians.

In the present embodiment, the vehicle 20a, the vehicle 20b, and the vehicle 20c are sometimes collectively referred to as “vehicle 20”. The in-vehicle processing device 40a, the in-vehicle processing device 40b, and the in-vehicle processing device 40c are sometimes collectively referred to as “in-vehicle processing device 40”. The assistance device 60a and the assistance device 60b are sometimes collectively referred to as “assistance device 60”. The user terminal 82a and the user terminal 82b are sometimes collectively referred to as “user terminal 82”. The user 80a and the user 80b are sometimes collectively referred to as “user 80”.

The vehicle 20 is a vehicle traveling on a road 90. The vehicle 20 is an example of a movable body. The in-vehicle processing device 40 is configured such that it includes a camera, a position sensor including a Global Navigation Satellite System (GNSS) receiver, and a speed sensor such as a vehicle speed sensor. The in-vehicle processing device 40 includes a function to process the information obtained by various sensors and a function to communication with the relay device 50 and the assistance device 60. The in-vehicle processing device 40 provides an Advanced Driving Assistance System (ADAS) function which is equipped in the vehicle 20.

The in-vehicle processing device 40 periodically transmits, to the relay device 50, the current position information of the vehicle 20 detected by a position sensor and the current speed information of the vehicle 20 detected by a speed sensor. The relay device 50 relays and transmits, to the assistance device 60, the information transmitted from the in-vehicle processing device 40. The relay device 50 receives, via mobile communication, the information transmitted from the in-vehicle processing device 40. The relay device 50 transmits the information, transmitted from the in-vehicle processing device 40, to the assistance device 60 through the communication line such as the Internet or a dedicated line. The in-vehicle processing device 40 may detect the mental condition of the driver of the vehicle 20 based on the image obtained by capturing the driver, the strength with which the driver grips the steering wheel, or the like, and transmit the information indicating the mental condition of the driver of the vehicle 20 to the relay device 50.

The user terminal 82 is a mobile terminal such as a smartphone, for example. The user terminal 82 periodically transmits, to the relay device 50, the current position information of the user terminal 82 detected by the position sensor including a GNSS receiver. The relay device 50 relays and transmits, to the assistance device 60, the information transmitted from the user terminal 82. The relay device 50 receives, via mobile communication, the information transmitted from the user terminal 82. The relay device 50 transmits the information, transmitted from the user terminal 82, to the assistance device 60 through a communication line such as the Internet or a dedicated line.

The relay device 50 relays and transmits, to the assistance device 60, the information transmitted from the capturing device 70. The relay device 50 receives, via mobile communication, the information transmitted from the capturing device 70. The relay device 50 transmits the information, transmitted from the capturing device 70, to the assistance device 60 through the communication line such as the Internet or a dedicated line. The information transmitted from the capturing device 70 includes the information obtained by analyzing the image captured by the capturing device 70. The capturing device 70 obtains the positions of the vehicle 20 and the user 80 existing within the capturing range of the capturing device 70 by analyzing the captured image and transmits the obtained positions of the vehicle 20 and the user 80 to the relay device 50.

The relay device 50 transmits the information received from the in-vehicle processing device 40 and the information received from the user terminal 82 to the assistance device 60 with anonymization. The assistance device 60 performs traffic assistance for the vehicle 20 based on the information received from the relay device 50. In the present embodiment, the assistance device 60a performs traffic assistance for the vehicle 20a and the assistance device 60b performs traffic assistance for the vehicle 20b. For example, when it is predicted that the user 80a of the user terminal 82a and the vehicle 20a will approach each other within a predetermined period based on the history of the position information and the speed information of the vehicle 20a and the history of the position information of the user terminal 82 and/or the history of the position information of the user 80, the assistance device 60a instructs the in-vehicle processing device 40a and the user terminal 82a to output an alarm. Similarly, when it is predicted that the user 80b of the user terminal 82b and the vehicle 20b will approach each other within a predetermined period based on the history of the position information and the speed information of the vehicle 20b and the history of the position information of the user terminal 82 and/or the history of the position information of the user 80, the assistance device 60b instructs the in-vehicle processing device 40b and the user terminal 82b to output an alarm.

In the present embodiment, the relay device 50 transmits the information, received from the in-vehicle processing device 40, with anonymization for each assistance device 60 which is the destination of the information. For example, the relay device 50 does not perform anonymization when transmitting, to the assistance device 60a, the information transmitted from the in-vehicle processing device 40a, while it performs anonymization when transmitting, to the assistance device 60b, the information transmitted from the in-vehicle processing device 40a. The relay device 50 does not perform anonymization when transmitting, to the assistance device 60b, the information transmitted from the in-vehicle processing device 40b, while it performs anonymization when transmitting, to the assistance device 60a, the information transmitted from the in-vehicle processing device 40b. The anonymization is performed by deleting the information, among the information received from the in-vehicle processing device 40, with which an individual can be identified or by replacing it with another information, for example. In this way, when the assistance device 60 performs traffic assistance based on privacy information such as the mental condition of the driver of the vehicle 20, for example, the information for the vehicle 20a for which the assistance device 60a provides traffic assistance can be utilized for the traffic assistance by identifying the vehicle 20a on the basis of a contract with the user of the vehicle 20a, while it can be ensured that the assistance device 60a cannot identify an individual for the user of the vehicle 20b for which the assistance device 60a does not provide the traffic assistance. Therefore, the personal data to be transmitted from the vehicle 20 can be appropriately handled.

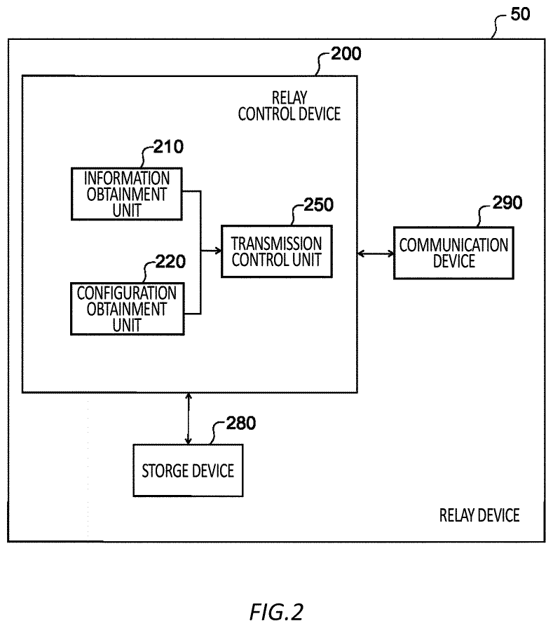

FIG. 2 shows a functional arrangement of the relay device 50. The relay device 50 includes a relay control device 200, a communication device 290, and a storage device 280.

The communication device 290 is responsible for the communication between each of the in-vehicle processing device 40, the user terminal 82, and the assistance device 60 and the relay device 50. The relay control device 200 is implemented such that it includes a circuit such as an arithmetic processing device including a processor, for example. The relay control device 200 may be implemented with a microcomputer including a CPU, a ROM, a RAM, an I/O, a bus, and the like. The storage device 280 is implemented by being provided with a non-volatile storage medium. The relay control device 200 performs the processing by using the information stored in the storage device 280.

The relay control device 200 includes an information obtainment unit 210, a configuration obtainment unit 220, and a transmission control unit 250. It is noted that an embodiment may be employed in which the relay device 50 does not have some functions among the functional arrangement shown in FIG. 2.

The information obtainment unit 210 obtains the information obtained from a plurality of vehicles 20. The transmission control unit 250 performs control for transmitting, to a plurality of assistance devices 60, the information obtained from the plurality of vehicles 20.

Specifically, the transmission control unit 250 performs control to determine, for each assistance device 60 which is the destination, the information to be transmitted with anonymization and the information transmitted without anonymization among the information obtained from the first vehicle 20 among the plurality of vehicles 20 and transmit, with anonymization, the information determined to be transmitted with anonymization and transmit, without anonymization, the information determined to be transmitted without anonymization, to each of the plurality of assistance devices 60. The first vehicle 20 may be the vehicle 20a and the second vehicle 20 may be the vehicle 20b.

As an example, the transmission control unit 250 determines to transmit the information, obtained from the first vehicle 20 among the plurality of vehicles 20, to the first assistance device 60 among the plurality of assistance devices 60 without anonymization, determines to transmit the information, obtained from the second vehicle 20 among the plurality of vehicles 20, to the first assistance device 60 with anonymization, determines to transmit the information, obtained from the second vehicle 20, to the second assistance device 60 among the plurality of assistance devices 60 without anonymization, and determines to transmit the information, obtained from the first vehicle 20, to the second assistance device 60 with anonymization. The first assistance device 60 may be the assistance device 60a and the second assistance device 60 may be the assistance device 60b.

As an example, the transmission control unit 250 may determine to transmit the first type of information among the information, obtained from the first vehicle 20 among the plurality of vehicles 20, to the first assistance device 60 among the plurality of assistance devices 60 without anonymization, determine to transmit the first type of information among the information, obtained from the second vehicle 20 among the plurality of vehicles 20, to the first assistance device 60 with anonymization, determine to transmit the first type of information among the information, obtained from the second vehicle 20, to the second assistance device 60 among the plurality of assistance devices 60 without anonymization, and determine to transmit the information of the first type among the information, obtained from the first vehicle 20, to the second assistance device 60 with anonymization.

The information obtained from the plurality of vehicles 20 may include the information indicating the mental condition of each occupant of the plurality of vehicles 20. In this case, the first type of information may include information indicating the mental condition of the occupant.

The first assistance device 60 may be the assistance device 60 which performs the traffic assistance for the first vehicle 20 and the second assistance device 60 may be the assistance device 60 which performs the traffic assistance for the second vehicle 20.

The transmission control unit 250 may perform anonymization by prohibiting the identification information of the plurality of vehicle 20 or the identification information of the occupant of the plurality of vehicles 20 from being transmitted.

The configuration obtainment unit 220 obtains the configuration information indicating whether to transmit the information with anonymization for each combination of the vehicle 20 which is the source of the information, the assistance device 60 which is the destination of the information, and the type of the information to be transmitted. For each assistance device 60 which is the destination, the transmission control unit 250 determines the information to be transmitted with anonymization and the information to be transmitted without anonymization among the information obtained from the first vehicle 20 among the plurality of vehicles 20 based on the configuration information.

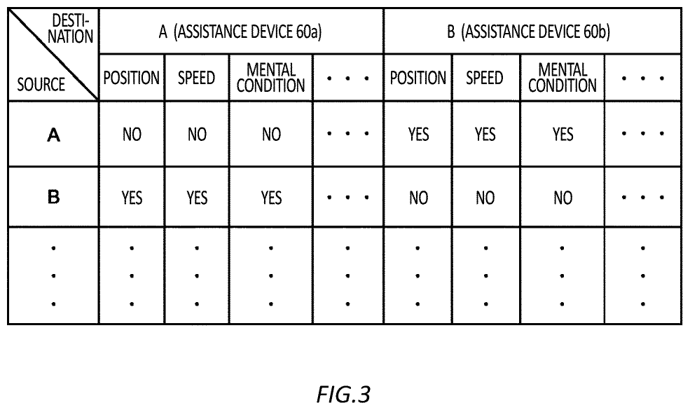

FIG. 3 shows the data structure of the configuration information for anonymization of the information to be transmitted to the relay device 50. The configuration information is stored in the storage device 280. The configuration information is the information to indicate whether to anonymize the information for each combination of the type of information to be transmitted to each assistance device 60 and the equipment which is the source of the information.

In FIG. 3, the “A” in the destination indicates the assistance device 60a and the “B” in the destination indicates the assistance device 60b. The “A” in the source indicates the equipment for which the traffic assistance is performed by the assistance device 60a and the “B” in the source indicates the equipment for which the traffic assistance is performed by the assistance device 60b. Specifically, in the present embodiment, the “A” in the source indicates the vehicle 20a and the user terminal 82a and the “B” in the source indicates the vehicle 20b and the user terminal 82b.

As shown in FIG. 3, the configuration information indicates that the information indicating the position, the speed, and the mental condition of the vehicle 20a is transmitted to the assistance device 60a without anonymization, and indicates that the information indicating the the position, the speed, and the mental condition of the vehicle 20a is transmitted to the assistance device 60b with anonymization. Furthermore, the configuration information indicates that the information indicating the position, the speed, and the mental condition of the vehicle 20b is transmitted to the assistance device 60a with anonymization and indicates that the information indicating the position, the speed, and the mental condition of the vehicle 20b is transmitted to the assistance device 60b without anonymization.

The transmission control unit 250 refers to the configuration information to determine whether to transmit the information with anonymization for each combination of the assistance device 60 which is the destination, the type of the information to be transmitted, and the equipment which is the source of the information.

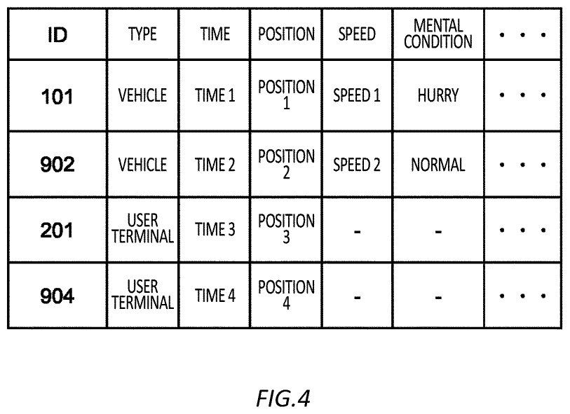

FIG. 4 shows an example of the information to be transmitted to the assistance device 60a. The information to be transmitted to the assistance device 60a includes the ID, the type, the time, the position, the speed, and the mental condition as the data items.

The ID is the information that identifies the source equipment from which the relay device 50 receives the information. It is assumed that the vehicle 20a, the vehicle 20b, the user terminal 82a, and the user terminal 82b are set with “101”, “102”, “201”, and “202” as the equipment identification information, respectively. The in-vehicle processing device 40a, the in-vehicle processing device 40b, the user terminal 82a, and the user terminal 82b add each equipment identification information to the information to be transmitted to the relay device 50.

The type is the information that indicates the type of the equipment. The type of equipment includes “vehicle” and “user terminal”. The position, the speed, and the mental condition are the information included in the information received from each of the in-vehicle processing device 40 and the user terminal 82.

The in-vehicle processing device 40a, the in-vehicle processing device 40b, the user terminal 82a, and the user terminal 82b pre-store assisting entity identification information that identifies from which assistance device 60 each of the vehicle 20 or the user terminal 82 receives traffic assistance. The in-vehicle processing device 40a, the in-vehicle processing device 40b, the user terminal 82a, and the user terminal 82b add the assisting entity identification information to the information to be transmitted to the relay device 50.

Based on the assisting entity identification information added to the information received from the in-vehicle processing device 40a and the configuration information shown in FIG. 3, the transmission control unit 250 does not perform anonymization for the information that is received from the in-vehicle processing device 40a and to be transmitted to the assistance device 60a and sets the equipment identification information “101”, which is set for the in-vehicle processing device 40a, as the ID. Based on the assisting entity identification information added to the information received from the user terminal 82a and the configuration information shown in FIG. 3, the transmission control unit 250 does not perform anonymization for the information that is received from the user terminal 82a and to be transmitted to the assistance device 60a and sets the equipment identification information “201”, which is set for the user terminal 82a, as the ID.

On the other hand, based on the assisting entity identification information added to the information received from the in-vehicle processing device 40b and the configuration information shown in FIG. 3, the transmission control unit 250 performs anonymization for the information which is received from the in-vehicle processing device 40b and to be transmitted to the assistance device 60a and thereby sets the “902”, which is added by the relay device 50, as the ID instead of setting the equipment identification information “101”, which is set for the in-vehicle processing device 40b, as the ID. Based on the assisting entity identification information added to the information received from the user terminal 82b and the configuration information shown in FIG. 3, the transmission control unit 250 performs anonymization for the information that is received from the user terminal 82b and to be transmitted to the assistance device 60a and thereby sets the “904”, which is added by the relay device 50, as the ID instead of setting the equipment identification information “202”, which is set for the user terminal 82b, as the ID. In this way, when transmitting, to the assistance device 60a, the information transmitted from the in-vehicle processing device 40b and the user terminal 82b, the relay device 50 can conceal the information that identifies an individual.

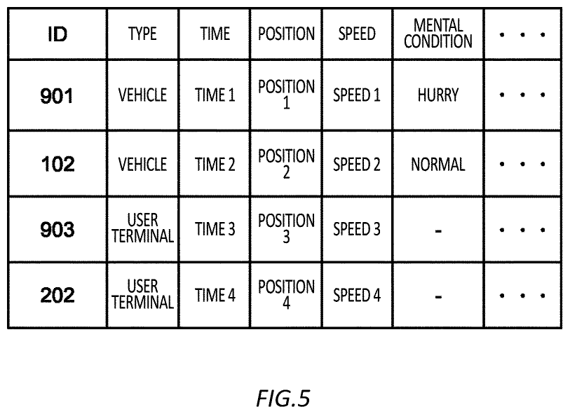

FIG. 5 shows an example of the information to be transmitted to the assistance device 60b. As with the information to be transmitted to the assistance device 60b, the information to be transmitted to the assistance device 60b includes the ID, the type, the time, the position, the speed, and the mental condition as the data items.

Based on the assisting entity identification information added to the information received from the in-vehicle processing device 40b and the configuration information shown in FIG. 3, the transmission control unit 250 does not perform anonymization for the information which is received from the in-vehicle processing device 40b and to be transmitted to the assistance device 60b and sets the equipment identification information “102”, which is set for the in-vehicle processing device 40b, as the ID. Based on the assisting entity identification information added to the information received from the user terminal 82b and the configuration information shown in FIG. 3, the transmission control unit 250 does not perform anonymization for the information which is received from the user terminal 82b and to be transmitted to the assistance device 60b and sets the equipment identification information “202”, which is set for the user terminal 82b, as the ID.

On the other hand, based on the assisting entity identification information added to the information received from the in-vehicle processing device 40a and the configuration information shown in FIG. 3, the transmission control unit 250 performs anonymization for the information that is received from the in-vehicle processing device 40a and to be transmitted to the assistance device 60b and thereby sets “901”, which is added by the relay device 50, as the ID instead of setting the equipment identification information “101”, which is set for the in-vehicle processing device 40a, as the ID. Based on the assisting entity identification information added to the information received from the user terminal 82a and the configuration information shown in FIG. 3, the transmission control unit 250 performs anonymization for the information that is received from the user terminal 82a and to be transmitted to the assistance device 60b and thereby sets “903”, which is added by the relay device 50, as the ID instead of setting the equipment identification information “201”, which is set by the user terminal 82a, as the ID. In this way, the relay device 50 can conceal the information that identifies an individual when transmitting, to the assistance device 60b, the information transmitted from the in-vehicle processing device 40a and the user terminal 82a.

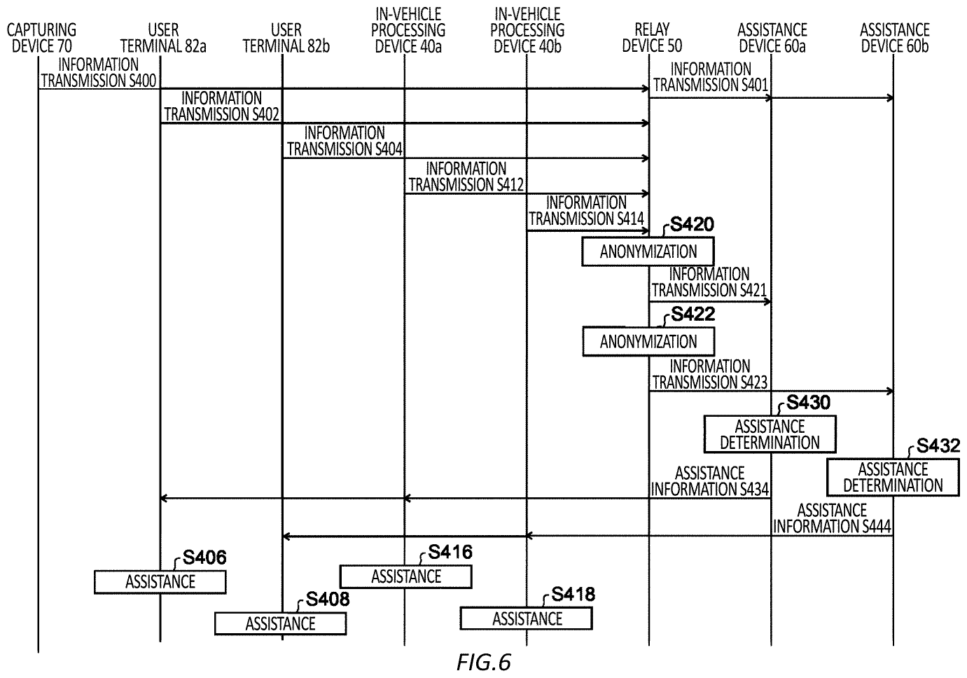

FIG. 6 shows an example of the execution sequence of the process of the capturing device 70, the user terminal 82, the in-vehicle processing device 40 included in the vehicle 20, the relay device 50, and the assistance device 60.

In S400, the capturing device 70 extracts the figure of pedestrians and vehicles from the image captured by the capturing device 70 and transmits the information indicating the positions of the extracted pedestrians and the vehicles to the relay device 50. For example, the capturing device 70 identifies the geological positions where the pedestrians and the vehicles extracted from the image exist, based on the position where the capturing device 70 is provided, the capturing condition and the capturing range of the capturing device 70, the size of the figures of the pedestrians and the vehicles extracted from the image, and the ground feature information indicating the ground feature installed within the capturing range of the capturing device 70. The capturing device 70 transmits the position information of the identified pedestrians and vehicles, the time, and the equipment identification information identifying the capturing device 70 to the relay device 50.

In S401, the transmission control unit 250 transmits, to the assistance device 60a and the assistance device 60b, the information received from the capturing device 70. The information received from the capturing device 70 does not include the information from which an individual related to the vehicle 20 and the user terminal 82 can be identified. Therefore, the transmission control unit 250 does not perform anonymization when transmitting, to the relay device 50, the information received from the capturing device 70.

In S402, the user terminal 82a transmits, to the relay device 50, the information including the current position of the user terminal 82a that is based on the signal received from the GNSS satellite. The equipment identification information of the user terminal 82a, the assisting entity identification information, and the time are added to the information transmitted from the user terminal 82a to the relay device 50.

In S404, the user terminal 82b transmits, to the relay device 50, the information including the current position of the user terminal 82b that is based on the signal received from the GNSS satellite. The equipment identification information of the user terminal 82b, the assisting entity identification information, and the time are added to the information transmitted from the user terminal 82b to the relay device 50. The user terminal 82a and the user terminal 82b periodically transmit the information including each current position to the relay device 50.

In S412, the in-vehicle processing device 40a transmits, to the relay device 50, the information indicating the current position of the in-vehicle processing device 40a based on the signal received from the GNSS satellite, the speed of the vehicle 20a, and the mental condition of the driver of the vehicle 20a. The equipment identification information of the in-vehicle processing device 40a, the assisting entity identification information, and the time are added to the information transmitted from the in-vehicle processing device 40a to the relay device 50.

In S414, the in-vehicle processing device 40b transmits, to the relay device 50, the information indicating the current position of the in-vehicle processing device 40b based on the signal received from the GNSS satellite, the speed of the vehicle 20b, and the mental condition of the driver of the vehicle 20b. The equipment identification information of the in-vehicle processing device 40b, the assisting entity identification information, and the time are added to the information transmitted from the in-vehicle processing device 40b to the relay device 50.

In S420, the transmission control unit 250 performs a process related to anonymization on the information that is received from the user terminal 82 and the in-vehicle processing device 40 and to be transmitted to the assistance device 60a. Specifically, as described with reference to FIG. 3 and FIG. 4, based on the configuration information, the transmission control unit 250 anonymizes the information that is set to be anonymized for the information to be transmitted to the assistance device 60a and does not anonymize the information that is set not to be anonymized.

Subsequently, in S421, the transmission control unit 250 transmits, to the assistance device 60a, the information on which the process related to anonymization was performed in S420.

In S422, the transmission control unit 250 performs a process related to anonymization on the information that is received from the user terminal 82 and the in-vehicle processing device 40 and to be transmitted to the assistance device 60b. Specifically, as described with reference to FIG. 3 and FIG. 5, based on the configuration information, the transmission control unit 250 anonymizes the information that is set to be anonymized for the information to be transmitted to the assistance device 60b and does not anonymize the information that is set not to be anonymized.

Subsequently, in S423, the transmission control unit 250 transmits, to the assistance device 60b, the information on which the process related to anonymization was performed in S422.

In S430, the assistance device 60a determines whether to perform traffic assistance for the user terminal 82a and the vehicle 20a based on the information received from the relay device 50 in S421 and the information received from the capturing device 70 in S401. For example, when it is determined that there is another vehicle 20 or a user terminal 82 that will approach the vehicle 20a within a predetermined first period based on the history of the position information and the speed information of the vehicle 20 and the history of the position information of the user terminal 82 and/or the history of the position information of the user 80, the assistance device 60a determines to perform traffic assistance for at least the vehicle 20a. Furthermore, when it is determined that there is a vehicle 20 that will approach the user terminal 82a within a predetermined first period based on the history of the position information and the speed information of the vehicle 20 and the history of the position information of the user terminal 82 and/or the history of the position information of the user 80, the assistance device 60a determines to perform traffic assistance for at least the user terminal 82a.

In another example, when it is determined that the driver of the vehicle 20a is in a hurry based on the mental condition of the driver of the vehicle 20 and it is determined that there is another vehicle 20 or a user terminal 82 that will approach the vehicle 20a within a predetermined second period based on the history of the position information and the speed information of the vehicle 20 and the history of the position information of the user terminal 82 and/or the history of the position information of the user 80, the assistance device 60a may determine to perform traffic assistance for at least the vehicle 20a. Furthermore, when it is determined that the driver of the vehicle 20a is in a hurry based on the mental condition of the driver of the vehicle 20 and it is determined that there is a vehicle 20a that will approach the user terminal 82a within a predetermined second period based on the history of the position information and the speed information of the vehicle 20 and the history of the position information of the user terminal 82 and/or the history of the position information of the user 80, the assistance device 60a may determine to perform traffic assistance for at least the user terminal 82a. Here, the second period may be longer than the first period. In this way, when it is determined that the driver of the vehicle 20a is in a hurry, traffic assistance can be performed earlier than when it is determined that the driver of the vehicle 20a is not in a hurry.

In the present embodiment, the assistance device 60a determines that the user 80a carrying the user terminal 82a and the vehicle 20a will approach each other within a predetermined period and, in S434, transmits, to each of the in-vehicle processing device 40a and the user terminal 82a, the assistance Information instructing the in-vehicle processing device 40a and the user terminal 82a to output an alarm.

When receiving the assistance Information from the assistance device 60a, in S406, the user terminal 82a uses the Human Machine Interface (HMI) function equipped in the user terminal 82a to inform the user 80a that there is a vehicle approaching the user 80a. The user terminal 82a may inform, through voice, the user 80a that there is a vehicle approaching the user 80a.

When receiving the assistance Information from the assistance device 60a, in S416, the in-vehicle processing device 40a uses the HMI function equipped in the in-vehicle processing device 40a to inform the occupant of the vehicle 20a that there is a user approaching the vehicle 20a. The in-vehicle processing device 40a may inform, through voice or display on the display device included in the vehicle 20a, the occupant of the vehicle 20a that there is a vehicle approaching the vehicle 20a.

In S432, the assistance device 60b determines whether to perform traffic assistance for the user terminal 82b and the vehicle 20b based on the information received from the relay device 50 in S423 and the information received from the capturing device 70 in S401. For example, when it is determined that there is another vehicle 20 or a user terminal 82 that will approach the vehicle 20b within a predetermined period based on the history of the position information and the speed information of the vehicle 20 and the history of the position information of the user terminal 82 and/or the history of the position information of the user 80, the assistance device 60b determines to perform traffic assistance for at least the vehicle 20b. Furthermore, when it is determined that there is a vehicle 20 that will approach the user terminal 82b within a predetermined period based on the history of the position information and the speed information of the vehicle 20 and the history of the position information of the user terminal 82 and/or the history of the position information of the user 80, the assistance device 60b determines to perform traffic assistance for at least the user terminal 82b.

In another example, when it is determined the driver of the vehicle 20b is in a hurry based on the mental condition of the driver of the vehicle 20 and it is determined that there is another vehicle 20 or a user terminal 82 that will approach the vehicle 20b within a predetermined second period based on the history of the position information and the speed information of the vehicle 20 and the history of the position information of the user terminal 82 and/or the history of the position information of the user 80, the assistance device 60b determines to perform traffic assistance for at least the vehicle 20b. Furthermore, when it is determined that the driver of the vehicle 20b is in a hurry based on the mental condition of the driver of the vehicle 20 and it is determined that there is a vehicle 20 that will approach the user terminal 82b within a predetermined second period based on the history of the position information and the speed information of the vehicle 20 and the history of the position information of the user terminal 82 and/or the history of the position information of the user 80, the assistance device 60b determines to perform traffic assistance for at least the user terminal 82b. In this way, when it is determined that the driver of the vehicle 20b is in a hurry, traffic assistance can be performed earlier than when it is determined that the driver of the vehicle 20b is not in a hurry.

In the present embodiment, the assistance device 60b determines that the user 80b carrying the user terminal 82b and the vehicle 20b will approach each other within a predetermined period, and, in S444, transmits, to each of the in-vehicle processing device 40b and the user terminal 82b, the assistance information instructing the in-vehicle processing device 40b and the user terminal 82b to output an alarm.

When receiving the assistance Information from the assistance device 60b, in S408, the user terminal 82b uses the HMI function equipped in the user terminal 82b to inform the user 80b that there is a vehicle approaching the user 80b. The user terminal 82b may inform, through voice, the user 80b that there is a vehicle approaching the user 80b.

When receiving the assistance Information from the assistance device 60b, in S418, the in-vehicle processing device 40b uses the HMI function equipped in the in-vehicle processing device 40b to inform the occupant of the vehicle 20b that there is a user approaching the vehicle 20b. The in-vehicle processing device 40b may inform, through voice and display on the display device included in the vehicle 20b, the occupant of the vehicle 20b that there is a vehicle approaching the vehicle 20b.

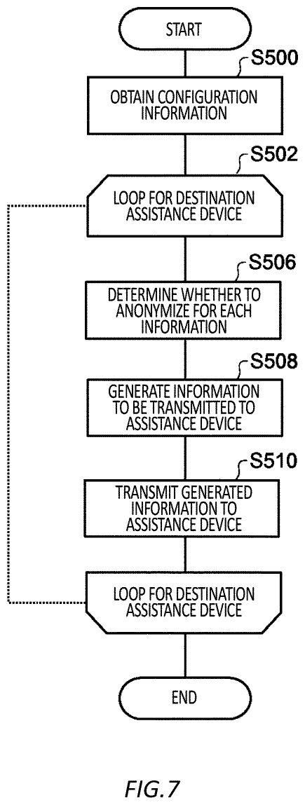

FIG. 7 shows an example of a flowchart related to the relay control method performed by the relay device 50. The process of this flowchart may be performed periodically.

In S500, the configuration obtainment unit 220 obtains configuration information for anonymization described with reference to FIG. 3 and the like. In S502, the transmission control unit 250 performs the loop processing that repeats the processes from S502 to S510 for the assistance device 60, which is the destination.

In S506, the transmission control unit 250 determines whether to anonymize the information to be transmitted to the assistance device 60 selected in the loop processing. In S508, the information to be transmitted to the assistance device 60 selected in the loop processing is generated. Specifically, in S508, the transmission control unit 250 generates the information to be transmitted to the assistance device 60 by anonymizing the information determined to be anonymized in S506 and not anonymizing the information determined not to be anonymized in S506. Subsequently, in S510, the information generated in S508 is transmitted to the assistance device 60 selected in the loop processing.

The assistance system 10 described above allows for transmitting the information related to the vehicle 20a and the user terminal 82a, to which the assistance device 60a provides traffic assistance, to the assistance device 60a without anonymization, while transmitting the information related to the vehicle 20b and the user terminal 82b, to which the assistance device 60a does not provide traffic assistance, to the assistance device 60a with anonymization. In this way, since personalized traffic assistance can be performed for the vehicle 20a and the user of the user terminal 82a, to which the assistance device 60a provides traffic assistance, the service related to traffic assistance can be improved. On the other hand, since the information related to the vehicle 20b and the user terminal 82b is transmitted to the assistance device 60a with anonymization, the information related to the vehicle 20b and the user terminal 82b, to which the assistance device 60a does not provide traffic assistance, can be more appropriately handled such that an individual cannot be identified.

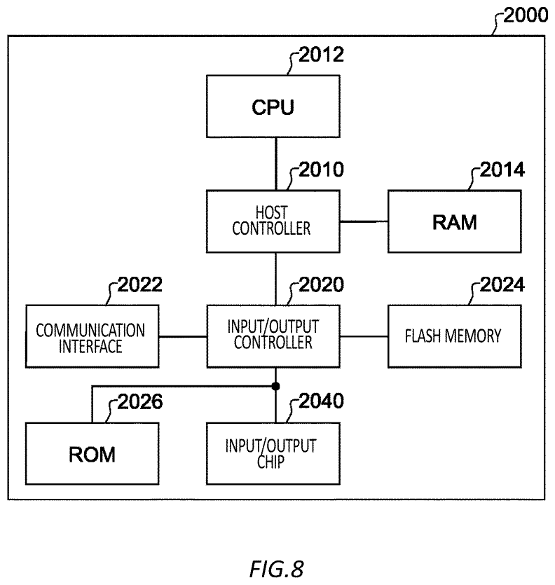

FIG. 8 shows an example of a computer 2000 where a plurality of embodiments of the present invention may be entirely or partially embodied. The program installed on the computer 2000 can cause the computer 2000 to function as a device such as the relay device 50 according to the embodiments or each unit of the device, to perform the operation associated with the device or each unit of the device, and/or to perform a process according to the embodiment or steps of the process. Such a program may be executed by a CPU 2012 in order to cause the computer 2000 to execute a specific operation associated with some or all of the processing procedures and the blocks in the block diagrams described herein.

The computer 2000 according to the present embodiment includes the CPU 2012 and a RAM 2014, which are mutually connected by a host controller 2010. The computer 2000 also includes a ROM 2026, a flash memory 2024, a communication interface 2022, and an input/output chip 2040. The ROM 2026, the flash memory 2024, the communication interface 2022, and the input/output chip 2040 are connected to the host controller 2010 via an input/output controller 2020.

The CPU 2012 operates according to programs stored in the ROM 2026 and the RAM 2014, and thereby controls each unit.

The communication interface 2022 communicates with another electronic device via a network. The flash memory 2024 stores a program and data used by the CPU 2012 in the computer 2000. The ROM 2026 stores a boot program or the like executed by the computer 2000 during activation, and/or a program depending on hardware of the computer 2000. The input/output chip 2040 may also connect various input/output units such as a keyboard, a mouse, and a monitor, to the input/output controller 2020 via input/output ports such as a serial port, a parallel port, a keyboard port, a mouse port, a monitor port, a USB port, a HDMI (registered trademark) port.

A program is provided via a network or a computer-readable storage medium such as a CD-ROM, a DVD-ROM, or a memory card. The RAM 2014, the ROM 2026, or the flash memory 2024 is an example of the computer-readable storage medium. The program is installed in the flash memory 2024, the RAM 2014, or the ROM 2026, and executed by the CPU 2012. Information processing written in these programs is read by the computer 2000, and provides cooperation between the programs and the various types of hardware resources described above. An device or a method may be actualized by executing operations or processing of information depending on a use of the computer 2000.

For example, when a communication is executed between the computer 2000 and an external device, the CPU 2012 may execute a communication program loaded in the RAM 2014, and instruct the communication interface 2022 to execute communication processing based on processing written in the communication program. Under the control of the CPU 2012, the communication interface 2022 reads transmission data stored in a transmission buffer processing region provided in a recording medium such as the RAM 2014 or the flash memory 2024, transmits the read transmission data to the network, and writes reception data received from the network into a reception buffer processing region or the like provided on the recording medium.

In addition, the CPU 2012 may cause all or a necessary portion of a file or a database stored in a recording medium such as the flash memory 2024 to be read into the RAM 2014, and execute various kinds of processing on the data on the RAM 2014. Next, the CPU 2012 writes back the processed data into the recording medium.

Various types of information such as various types of programs, data, a table, and a database may be stored in the recording medium and may be subjected to information processing. The CPU 2012 may execute, on the data read from the RAM 2014, various kinds of processing including various kinds of operations, information processing, conditional judgement, conditional branching, unconditional branching, information retrieval/replacement, or the like described herein and specified by instruction sequences of the programs, and write back a result into the RAM 2014. In addition, the CPU 2012 may retrieve information in a file, a database, or the like in the recording medium. For example, when multiple entries each having an attribute value of a first attribute associated with an attribute value of a second attribute, is stored in the recording medium, the CPU 2012 may retrieve an entry having a designated attribute value of the first attribute that matches a condition from these multiple entries, and read the attribute value of the second attribute stored in this entry, thereby obtaining the attribute value of the second attribute associated with the first attribute that satisfies a predetermined condition.

The programs or software modules described above may be stored in the computer-readable storage medium on the computer 2000 or in the vicinity of the computer 2000. A recording medium such as a hard disk or a RAM provided in a server system connected to a dedicated communication network or the Internet can be used as the computer-readable storage medium. A program stored in the computer-readable storage medium may be provided to the computer 2000 via a network.

The program that is installed on the computer 2000 and causes the computer 2000 to function as the relay device 50 may instruct the CPU 2012 and the like to cause the computer 2000 to each function as each unit of the relay device 50 (for example, the relay control device 200). The information processing described in these programs is read by the computer 2000 to function as each unit of the relay device 50 which is specific means in which software and various hardware resources described above cooperate. These specific means implement operations or processing of information according to the intended use of the computer 2000 in the present embodiment, and the relay device 50 is thereby constructed to be specific for the intended use.

Various embodiments have been described with reference to the block diagrams and the like. In the block diagrams, each block may represent (1) a stage of a process in which an operation is executed, or (2) each unit of the device having a role in executing the operation. A specific stage and each unit may be implemented by a dedicated circuit, a programmable circuit supplied with computer-readable instructions stored on a computer-readable storage medium, and/or a processor supplied with computer-readable instructions stored on a computer-readable storage medium. The dedicated circuit may include a digital and/or analog hardware circuit, or may include an integrated circuit (IC) and/or a discrete circuit. The programmable circuit may include a reconfigurable hardware circuit including logical AND, logical OR, logical XOR, logical NAND, logical NOR, and another logical operation, and a memory element such as a flip-flop, a register, a field programmable gate array (FPGA), a programmable logic array (PLA), or the like.

The computer-readable storage medium may include any tangible device capable of storing instructions to be executed by an appropriate device. Thereby, the computer-readable storage medium having instructions stored therein forms at least a part of a product including instructions which can be executed to provide means for executing processing procedures or operations specified in the block diagrams. Examples of the computer-readable storage medium may include an electronic storage medium, a magnetic storage medium, an optical storage medium, an electromagnetic storage medium, a semiconductor storage medium, and the like. More specific examples of the computer-readable storage medium may include a floppy (registered trademark) disk, a diskette, a hard disk, a random access memory (RAM), a read only memory (ROM), an erasable programmable read only memory (EPROM or flash memory), an electrically erasable programmable read only memory (EEPROM), a static random access memory (SRAM), a compact disk read only memory (CD-ROM), a digital versatile disc (DVD), a Blu-ray (registered trademark) disc, a memory stick, an integrated circuit card, or the like.

The computer-readable instructions may include an assembler instruction, an instruction-set-architecture (ISA) instruction, a machine instruction, a machine dependent instruction, a microcode, a firmware instruction, state-setting data, or either of source code or object code written in any combination of one or more programming languages including an object oriented programming language such as Smalltalk (registered trademark), JAVA (registered trademark), and C++, and a conventional procedural programming language such as a “C” programming language or a similar programming language.

Computer-readable instructions may be provided to a processor of a general purpose computer, a special purpose computer, or another programmable data processing device, or to programmable circuit, locally or via a local area network (LAN), wide area network (WAN) such as the Internet, and a computer-readable instruction may be executed to provide means for executing operations specified in the described processing procedures or block diagrams. Examples of the processor include a computer processor, a processing unit, a microprocessor, a digital signal processor, a controller, a microcontroller, and the like.

While the present invention has been described by way of the embodiments, the technical scope of the present invention is not limited to the scope described in the above-described embodiments. It is apparent to persons skilled in the art that various alterations or improvements can be made to the above-described embodiments. It is also apparent from description of the claims that the embodiments to which such alterations or improvements are made can be included in the technical scope of the present invention.

The operations, procedures, steps, and stages etc. of each process performed by a device, system, program, and method shown in the claims, specification, or diagrams can be executed in any order as long as the order is not indicated by “before”, “prior to”, or the like and as long as the output from a previous process is not used in a later process. Even if the operation flow is described using phrases such as “first” or “next” for the sake of convenience in the claims, specification, or drawings, it does not necessarily mean that the process must be performed in this order.

### EXPLANATION OF REFERENCES

10: assistance system;
20; vehicle
40: in-vehicle processing device;
60: assistance device;
50; relay device;
60: assistance device;
70: capturing device;
80: user;
82: user terminal;
90: road;
210: information obtainment unit;
220: configuration obtainment unit
250: transmission control unit;
280: storage device;
290: communication device;
2000: computer;
2010: host controller;
2012: CPU;
2014: RAM
2020: input/output controller;
2022: communication interface;
2024: flash memory;
2026: ROM;
2040: input/output chip.

What is claimed is:

1. A relay control device comprising:
an information obtainment unit which obtains information obtained from a plurality of movable bodies; and
a transmission control unit which performs control for transmitting information obtained from the plurality of movable bodies to a plurality of assistance devices,
wherein the transmission control unit performs control for determining information to be transmitted with anonymization and information to be transmitted without anonymization among information obtained from a first movable body among the plurality of movable bodies for each destination assistance device and transmitting, with anonymization, information determined to be transmitted with anonymization and transmitting, without anonymizing, information determined not to be anonymized, to each of the plurality of assistance devices.

2. The relay control device according to claim 1, wherein the transmission control unit:
determines to transmit information obtained from the first movable body among the plurality of movable bodies to a first assistance device among the plurality of assistance devices without anonymization;
determines to transmit information obtained from a second movable body among the plurality of movable bodies to the first assistance device with anonymization;
determines to transmit information obtained from the second movable body to a second assistance device among the plurality of assistance devices without anonymization; and
determines to transmit information obtained from the first movable body to the second assistance device with anonymization.

3. The relay control device according to claim 1, wherein the transmission control unit:
determines to transmit a first type of information among information obtained from the first movable body among the plurality of movable bodies to a first assistance device among the plurality of assistance devices without anonymization;
determines to transmit the first type of information among information obtained from a second movable body among the plurality of movable bodies to the first assistance device with anonymization;
determines to transmit the first type of information among information obtained from the second movable body to a second assistance device among the plurality of assistance devices without anonymization; and
determines to transmit the first type of information among information obtained from the first movable body to the second assistance device with anonymization.

4. The relay control device according to claim 3, wherein information obtained from the plurality of movable bodies includes information indicating a mental condition of each occupant of the plurality of movable bodies, and
the first type of information includes information indicating the mental condition of the occupant.

5. The relay control device according to claim 2, wherein the first assistance device is an assistance device which performs traffic assistance for the first movable body, and
the second assistance device is an assistance device which performs traffic assistance for the second movable body.

6. The relay control device according to claim 1, wherein the transmission control unit performs anonymization by prohibiting transmission of identification information of the plurality of movable bodies or identification information of occupants of the plurality of movable bodies.

7. The relay control device according to claim 1, further comprising a configuration obtainment unit which obtains configuration information indicating whether to transmit information with anonymization for each combination of a source of information, a destination assistance device, and a type of information to be transmitted,
wherein the transmission control unit determines information to be transmitted with anonymization and information to be transmitted without anonymization among information obtained from the first movable body among the plurality of movable bodies based on the configuration information for each destination assistance device.

8. The relay control device according to claim 3, wherein the first assistance device is an assistance device which performs traffic assistance for the first movable body, and
the second assistance device is an assistance device which performs traffic assistance for the second movable body.

9. The relay control device according to claim 4, wherein the first assistance device is an assistance device which performs traffic assistance for the first movable body, and
the second assistance device is an assistance device which performs traffic assistance for the second movable body.

10. The relay control device according to claim 2, wherein the transmission control unit performs anonymization by prohibiting transmission of identification information of the plurality of movable bodies or identification information of occupants of the plurality of movable bodies.

11. The relay control device according to claim 3, wherein the transmission control unit performs anonymization by prohibiting transmission of identification information of the plurality of movable bodies or identification information of occupants of the plurality of movable bodies.

12. The relay control device according to claim 4, wherein the transmission control unit performs anonymization by prohibiting transmission of identification information of the plurality of movable bodies or identification information of occupants of the plurality of movable bodies.

13. The relay control device according to claim 5, wherein the transmission control unit performs anonymization by prohibiting transmission of identification information of the plurality of movable bodies or identification information of occupants of the plurality of movable bodies.

14. The relay control device according to claim 2, further comprising a configuration obtainment unit which obtains configuration information indicating whether to transmit information with anonymization for each combination of a source of information, a destination assistance device, and a type of information to be transmitted,
wherein the transmission control unit determines information to be transmitted with anonymization and information to be transmitted without anonymization among information obtained from a first movable body among the plurality of movable bodies based on the configuration information for each destination assistance device.

15. The relay control device according to claim 3, further comprising a configuration obtainment unit which obtains configuration information indicating whether to transmit information with anonymization for each combination of a source of information, a destination assistance device, and a type of information to be transmitted,
wherein the transmission control unit determines information to be transmitted with anonymization and information to be transmitted without anonymization among information obtained from the first movable body among the plurality of movable bodies based on the configuration information for each destination assistance device.

16. The relay control device according to claim 4, further comprising a configuration obtainment unit which obtains configuration information indicating whether to transmit information with anonymization for each combination of a source of information, a destination assistance device, and a type of information to be transmitted,
wherein the transmission control unit determines information to be transmitted with anonymization and information to be transmitted without anonymization among information obtained from the first movable body among the plurality of movable bodies based on the configuration information for each destination assistance device.

17. The relay control device according to claim 5, further comprising a configuration obtainment unit which obtains configuration information indicating whether to transmit information with anonymization for each combination of a source of information, a destination assistance device, and a type of information to be transmitted,
wherein the transmission control unit determines information to be transmitted with anonymization and information to be transmitted without anonymization among information obtained from the first movable body among the plurality of movable bodies based on the configuration information for each destination assistance device.

18. The relay control device according to claim 1, wherein the plurality of movable bodies are vehicles.

19. A relay control method comprising:
obtaining information obtained from a plurality of movable bodies; and
performing control for transmitting information obtained from the plurality of movable bodies to a plurality of assistance devices,
wherein performing control for transmitting information obtained from the plurality of movable bodies to the plurality of assistance devices includes performing control for determining information to be transmitted with anonymization and information to be transmitted without anonymization among information obtained from a first movable body among the plurality of movable bodies for each destination assistance device and transmitting, with anonymization, information determined to be transmitted with anonymization and transmitting, without anonymizing, information determined not to be anonymized, to each of the plurality of assistance devices.

20. A computer-readable storage medium that stores a program thereon, wherein the program causes a computer to function as:
an information obtainment unit which obtains information obtained from a plurality of movable bodies; and
a transmission control unit which performs control for transmitting information obtained from the plurality of movable bodies to a plurality of assistance devices,
wherein the transmission control unit performs control for determining information to be transmitted with anonymization and information to be transmitted without anonymization among information obtained from a first movable body among the plurality of movable bodies for each destination assistance device and transmitting, with anonymization, information determined to be transmitted with anonymization and transmitting, without anonymizing, information determined not to be anonymized, to each of the plurality of assistance devices.
